(19) United States
(12) Patent Application Publication
(10) Pub. No.: US 2005/0236243 A1
(43) Pub. Date: Oct. 27, 2005

(54) Cable winding reel and adaptor connecting device

(76) Inventor: Yea Yen Huang, Tocheng City (TW)

Correspondence Address: TROXELL LAW OFFICE PLLC, SUITE 1404, 5205 LEESBURG PIKE, FALLS CHURCH, VA, 22041, US

(21) Appl. No.: 10/851,193

(22) Filed: May 24, 2004

(30) Foreign Application Priority Data
Apr. 27, 2004 (TW) 093206444

(51) Int. Cl. H02G 11/02; B65H 75/48

(52) U.S. Cl. 191/12.4; 242/385

(57) ABSTRACT

This invention relates to a connecting device capable of pairing and adapting a cable winding reel structure with and to other relevant products, particularly to a connecting device capable of randomly pairing and adapting a cable winding reel with and to other assembly, such as a HUB, card reader, net wireless transmitter or power transformer, wherein the cable winding reel and assembly are connected by means of a terminal to allow various combinations so as to improve the applicability and value of the invention.

### FIELD OF THE INVENTION

This invention relates to a connecting device capable of pairing and adapting a cable winding reel structure with and to other relevant products, particularly to a connecting device capable of randomly pairing and adapting a cable winding reel with and to another assembly, such as a HUB, card reader, net wireless transmitter or power transformer, wherein the cable winding reel and assembly are connected by means of a terminal to allow various combinations so as to improve the applicability and value of the invention.

### BACKGROUND OF THE INVENTION

Due to the continuing progress of computer technology, the development of peripheral devices, and the rising of LAN, the applications of computers have become universally accepted throughout the word. Such developments also have resulted in complicated issues in the connecting of various peripheral devices for computers with portable computers, desktop computers and computer servers.

The commonly known peripheral devices, such as printers, scanners, video monitors, outer disk drivers, keyboards, computer mice, modems, card readers, digital cameras, outer boxes, net wireless transmitters and HUB, all need to be connected to servers, regardless of their size, through wires or auxiliary wiring devices to allow proper operations, which is the reason why the computer industry has worked hard to explore ways for connecting such devices to computer servers or relevant operation systems in a reasonable manner while supplying power required by such devices along with the transmission of signals at the same time.

The computer industry has, thus, developed the so-called USB, IEEE 1394 and PS2 interfaces that are capable of resolving the problems found in connecting the computer peripheral devices, and serve as the connection between computer servers and peripheral devices. The advantages provided by USB, 1394 and PS2 interfaces include that multiple computers or multiple peripheral devices may be collected by a HUB or ports prior to being connected to a computer server so as to resolve the problem of power supply found in connecting the computer and the peripheral devices.

USB, IEEE 1394, PS2 and RJ45 interfaces have been widely implemented in computer servers, portable computers or HUB, to allow easy and convenient connections.

Most of the computer peripheral devices, such as outer disk drivers, modems, card readers, digital cameras, outer boxes, net wireless transmitters and HUBs, or even chargers for mobile phones are powered by DC current.

Due to the variety of medium power cords or signal wires for connecting computer related devices, the technicians usually need to be equipped with a large variety of wires or cables, such as computer cables/wires used by computer users or service men, and transmission wires used by transmission service men, in actual applications. To allow easy carriage and to prevent complicated wiring, a variety of reeling boxes of signal or power wires implemented in computer-related devices have been developed.

However, the conventional cable reeling boxes are only reeling boxes or HUBs designed to reel in cables/wire, power transformers designed to transform AC current into DC current, card readers, mobile phone chargers, or net wireless transmitters featured with specific, rather than universal, functions, let along the capability of allowing different combinations.

In view of the simple function provided by the conventional cable reeling boxes and products, this invention combines the functions of cable/wire reeling, HUBs, power transformers, card readers and mobile phone chargers into a single device to improve the diversity of the winding reel, wherein adaptor combinations are implemented to allow random pairing and adapting of cable reeling boxes for transmitting power and signals with and to the aforementioned HUBs, power transformers, card readers and mobile phone chargers, thereby providing a cable winding reel and adaptor connecting device featuring multiple functions and allowing various combinations.

### SUMMARY OF THE INVENTION

This invention provides a connecting device capable of pairing and adapting a cable winding reel with and to other assemblies, such as a HUB, a card reader, a net wireless transmitter or a power transformer. The winding reel includes a cable for transmitting power and signals, which cable may be extended or retracted. The cable is provided at an end thereof a USB, IEEE 1394, PS2 or RJ45 plug, and connected at another end thereof with a terminal having an extended terminal of the assembly, such as the HUB, card reader, net wireless transmitter or power transformer, such that the winding reel of this invention may be randomly paired with and adapted to various computer peripheral devices.

### BRIEF DESCRIPTION OF THE DRAWINGS

These and other modifications and advantages will become even more apparent from the following detailed description of a preferred embodiment of the invention and from the drawings in which:

FIG. 1 is an exploded, perspective view of a cable winding reel and assembly according to this invention.

FIG. 2 is another exploded, perspective view of the cable winding reel according to this invention.

FIG. 3 is an exploded, perspective view illustrating the structure of cable winding reel according to this invention for controlling a signal/power cable.

FIG. 4 illustrates a top plan view and a cross-sectional view of a top lid shown in FIG. 3.

FIG. 5 illustrates a top plan view and a cross-sectional view of a top lid and a retaining block shown in FIG. 3.

FIG. 6 illustrates a cross-sectional view of a casing, cover and a retaining block shown in FIG. 3.

FIG. 7 is an exploded, perspective view of a USB HUB according to this invention.

FIG. 8 is an exploded, perspective view of a cable winding reel and USB HUB according to this invention.

FIG. 9 is an assembled, perspective view of a cable winding reel and USB HUB according to this invention.

FIG. 10 is a perspective view illustrating an embodiment of a cable winding reel and IEEE 1394 HUB assembly according to this invention.

FIG. 11 is perspective view illustrating an embodiment of a cable winding reel and card reader assembly according to this invention.

FIG. 12 is perspective view illustrating an embodiment of a cable winding reel and net wireless transmitter assembly according to this invention.

FIG. 13 is perspective view illustrating an embodiment of a cable winding reel and power transformer according to this invention.

### DETAILED DESCRIPTION OF THE INVENTION (PREFERRED EMBODIMENTS)

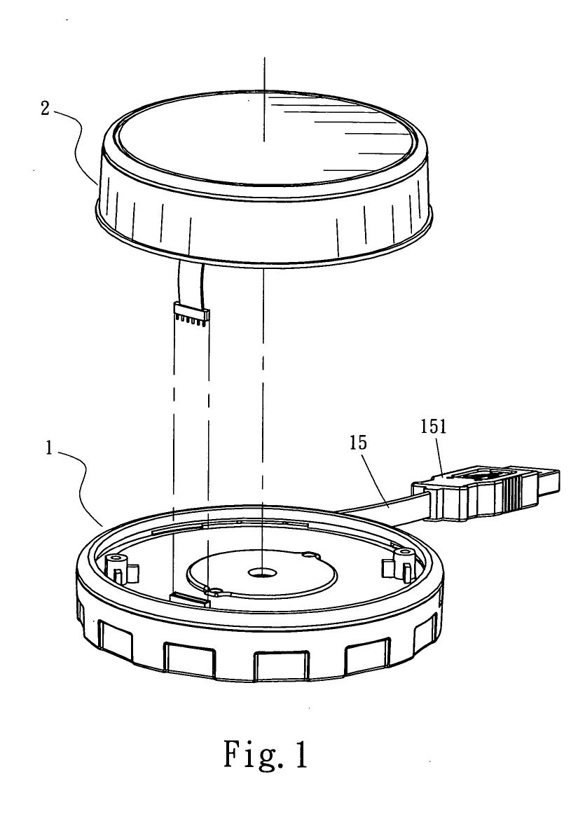

FIG. 1 illustrates cable winding reel and adaptor connecting device of this invention, where the device is capable of randomly pairing and adapting the cable winding reel with and to an assembly, such as a HUB, a card reader, a net wireless transmitter or a power transformer. The device includes a cable winding reel 1 and an assembly 2.

The assembly 2 in the device, in actual applications, may be a HUB 3 for USB, IEEE 1394 or PS2 interfaces, a card reader 4, a net wireless transmitter 5, a power transformer 6 or any other assembly of power or electronic devices.

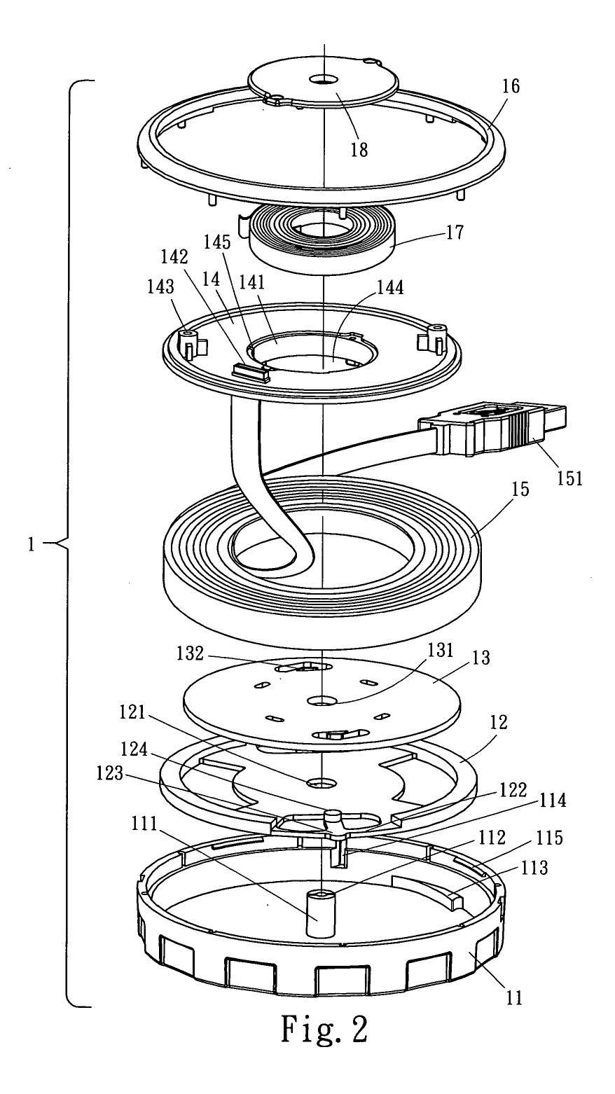

As shown in FIG. 2, the cable winding reel 1 includes a casing 11, a retaining disc 12, a control disc 13, a cover 14, a signal/power cable 15, a frame 16, a resilient spring 17 and a lid 18. The casing 11 has an open end and an inner periphery serving as a receiving compartment that is provided at a center thereof with a vertical post 111 formed with a groove 112 at an end. The casing 11 is provided at the inner circumferential periphery with an arcuate block 113. The casing 11 is provided at an outer periphery with a leading bore 114 for leading out the signal/power cable 15, and at a top edge thereof with a clip 115.

The retaining disc 12 and control disc 13 are each provided with a central bore 121, 131 corresponding to the vertical post 111, and are placed in the receiving compartment of the casing 11 in order. The retaining disc 12 is provided at an outer edge thereof with a set of resilient member 122 having a protrusion 123 at an outer edge thereof. The resilient member 122 is provided with a flange 124 facing upwards. The control disc 13 is provided with two symmetrical arcuate slots 132 at locations corresponding to the circumferential line of the flange 124, such that flange 124 may be inserted into either arcuate slot 132.

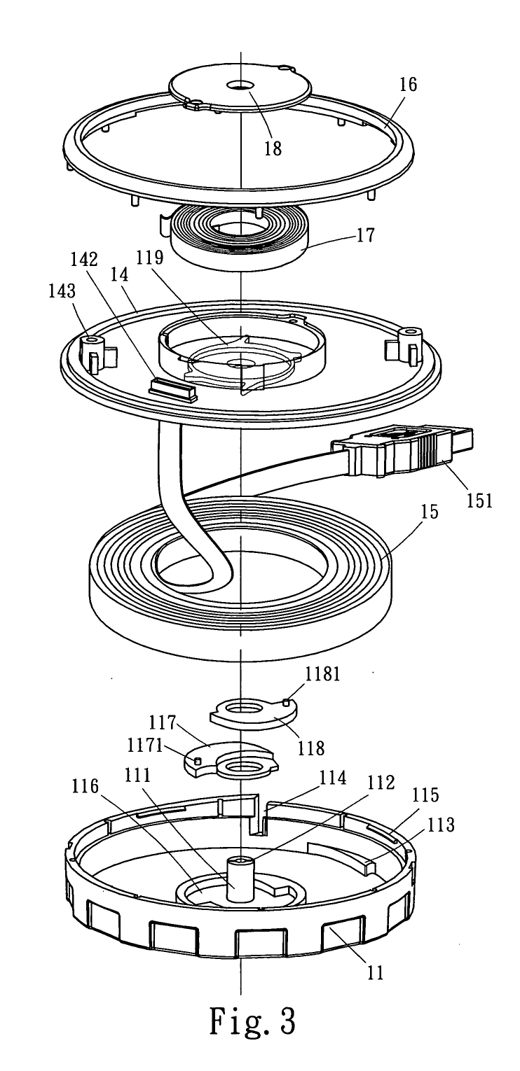

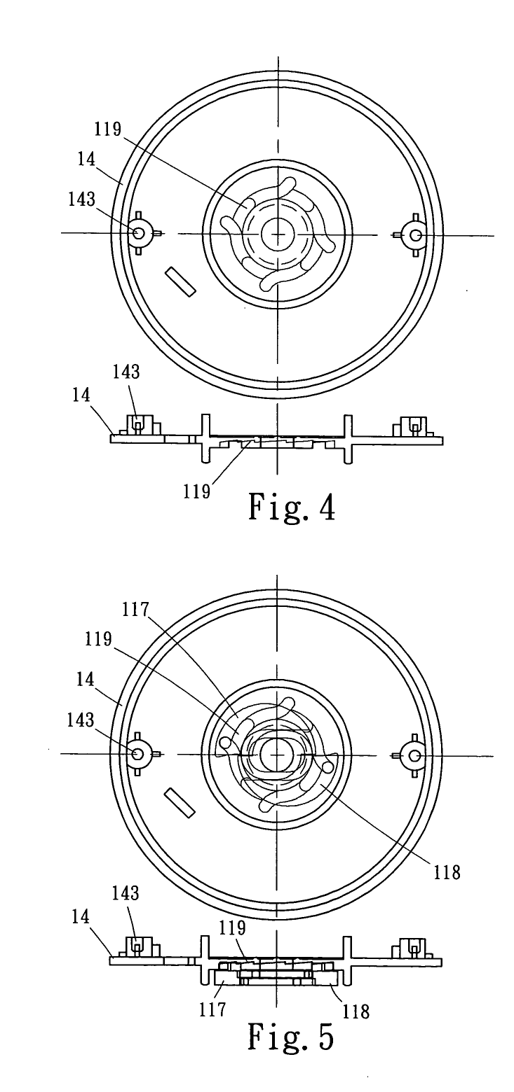

The signal/power cable 15 in this invention may be stretched and retracted in a manner as shown in the embodiment in FIGS. 3, 4 or 5. The casing 11 is provided at a bottom thereof with a retaining indent 116, and two retaining blocks 117, 118. The retaining blocks 117, 118 are provided thereto with posts 1171, 1181. The cover 14 is provided with an inclined guide 119 facing downwards at a location corresponding to the posts 1171, 1181, such that the posts 1171, 1181 are able to slide along the inclined guide 119. The inclined guide 119 includes a varying slope and a step at each of 45° intervals to serve as a stop.

When the cover 14 is rotated clockwise, such that the posts 1171, 1181 would slide along the inclined guide 119, the posts would be retained at an inner side for every 45° interval. When the cover 14 is rotated counter-clockwise to relax the cover by 90°, the two opposing retaining blocks 117, 118 would slide outwards along the inclined guide 119 and the posts would then be retained at an outer side. Thus, when the posts are retained at the inner side, the two opposing retaining blocks 117, 118 are allowed to rotate freely, such that the cover 14 is allowed to rotate freely. When the posts are retained at the outer side, the opposing retaining blocks 117, 118 would be staggered such that they each retain to the stagger indents formed on the lower lid, thereby retaining the rotating cover 14. When the cover 14 is rotated clockwise again, the retaining blocks 117, 118 would be driven to move inwards and towards the inclined guide 119, such that the posts are retained at the inner side. At this time, the rotating cover 14 is allowed to rotate freely again to accomplish the same control operation.

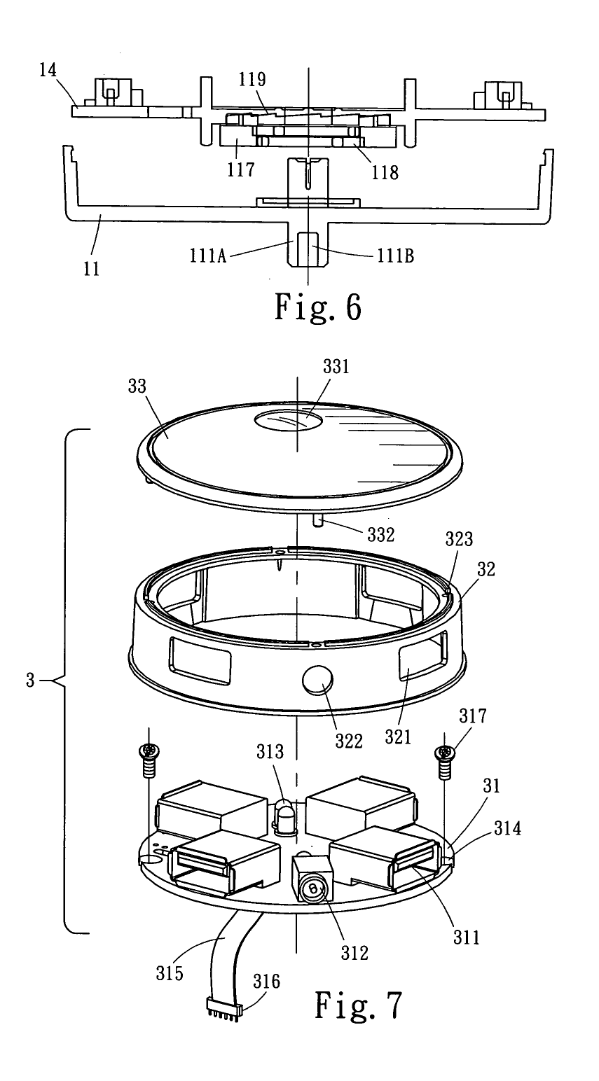

With reference to FIG. 6, the casing 11 may be provided at a central outer edge thereof, if necessary, with an assembly device 111A. The axis 111B of the assembly device 111B is provided with a screw hole or a retainer 121 that may be adapted to the screw rod of a rubber or magnetic sucking disc disclosed in the co-owned TW092215445U, CN03209024.2, JP2003-271463, U.S. Ser. No. 10/658,329 and DE20315331.6 patent cases, entitled “Multi-Function Hanging and Fastening Device,” thereby attaching the cable winding reel and adaptor connecting device of this invention to a glass or metal sheet.

The cover 14 is provided at a center thereof with a tubular opening 141 extending downwards. The cover 14 is provided thereto with a terminal 142 and screw holes 143. The tubular opening 141 includes an outer periphery about which the signal/power cable 15 may wind. The signal/power cable 15 has an end that is led out from the leading bore 114, and another end is connected to a USB plug 151. The USB plug 151, if necessary, may be replaced with an IEEE 1394 plug 151A (as shown in FIG. 10), a PS2 plug, or an RJ45 plug. The other end of the signal/power cable 15 passes through the cover 14 and is connected to the terminal 142.

After the signal/power cable 15 is mounted into the cover 14, the sub-assembly is inserted into the casing 11 and retained by the clip 115. The sub-assembly is then inserted into a frame 16. The tubular opening 141 of the cover 14 includes a hollow part 144 into which a resilient spring 17 is provided. The resilient spring 17 has an end affixed to the groove 112 of the vertical post 111, and another end affixed to a notch 145 of the cover 14. A lid 18 then covers over a top opening of the tubular opening 141.

As such, upon rotating the retaining disc 12, the protrusion 123 located at the outer edge of the resilient member 122 would be urged by the arcuate block 113 of the casing 1, so as to move the resilient member 122 and flange 124 outwards and inwards, such that the signal/power cable 15 would not retract when the user of the invention has stretched the signal/power cable 15 to a desired length. Upon a moderate pulling of the signal/power cable 15, the flange 124 of the resilient member 122 would be restrained at a location close to the center of the arcuate slot 132. As such, the protrusion 123 of the resilient member 122 would be retracted inwards and disengage from arcuate block 113 provided at the inner peripheral edge of the casing 11, whereby the signal/power cable 15 would be reeled into the casing due to the tension of the resilient spring 5.

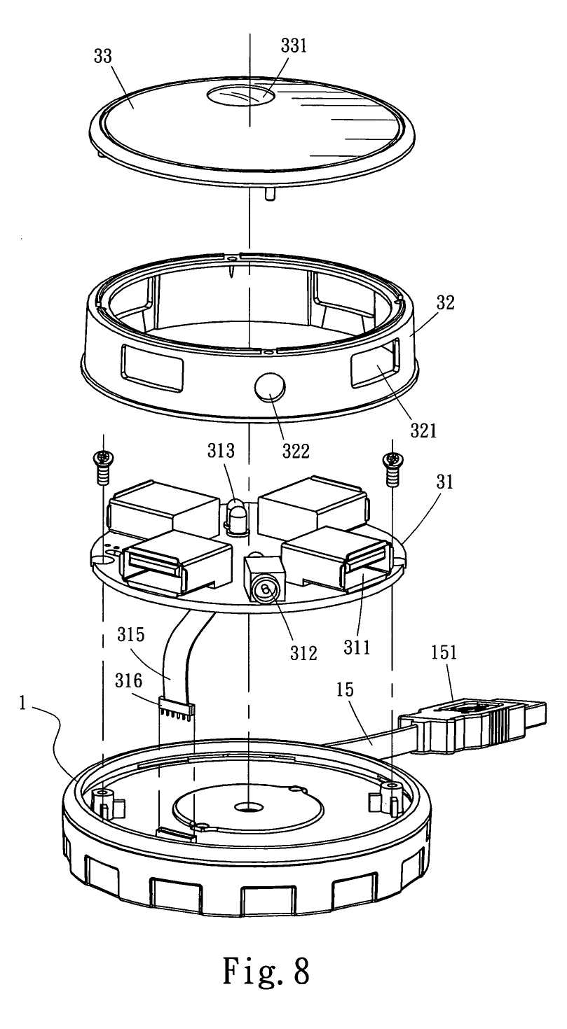

The cable winding reel 1 of this invention is shown in FIGS. 1 and 8 upon assembly. Other than the cable winding reel 1, this invention is further characterized in that the cable winding reel 1 may be paired with the assembly 2 to provide various combinations. The assembly 2, in actual applications, may be a HUB 3 for USB, IEEE 1394 or PS2 interfaces, a card reader 4, a net wireless transmitter 5, power transformer 6 or any other assembly, such as a power extension socket.

With reference to FIG. 7, the assembly 2 is a HUB 3 for USB interfaces. The USB HUB 3 includes a printed circuit board 31, a hood 32 and a top lid 33. The printed circuit board 31 is provided thereto with USB sockets 311, a power input terminal 312, an LED 313, and screw openings 314 at opposing ends thereof. The circuitry on the printed circuit board 3 is connected to an extension cord 315 at a backside thereof. The extension cord 315 is provided at an end thereof with a terminal 316 mating with the terminal 142 provided to the cover 14 of the cable winding reel 1.

The hood 32 is provided at locations corresponding to the USB sockets 311 and power input terminal 312 with USB socket openings 321, a power input opening 322 and a positioning hole 323 at a top side thereof. The hood 32 is covered with the top lid 33 for covering a top opening thereof. The top lid 33 is provided at a location corresponding to the LED 313 with a light-pervious plate 331. The top lid 33 is covered over and secured to the hood 32 by inserting a post 332 extending downwards into the positioning hole 323.

Actual Applications

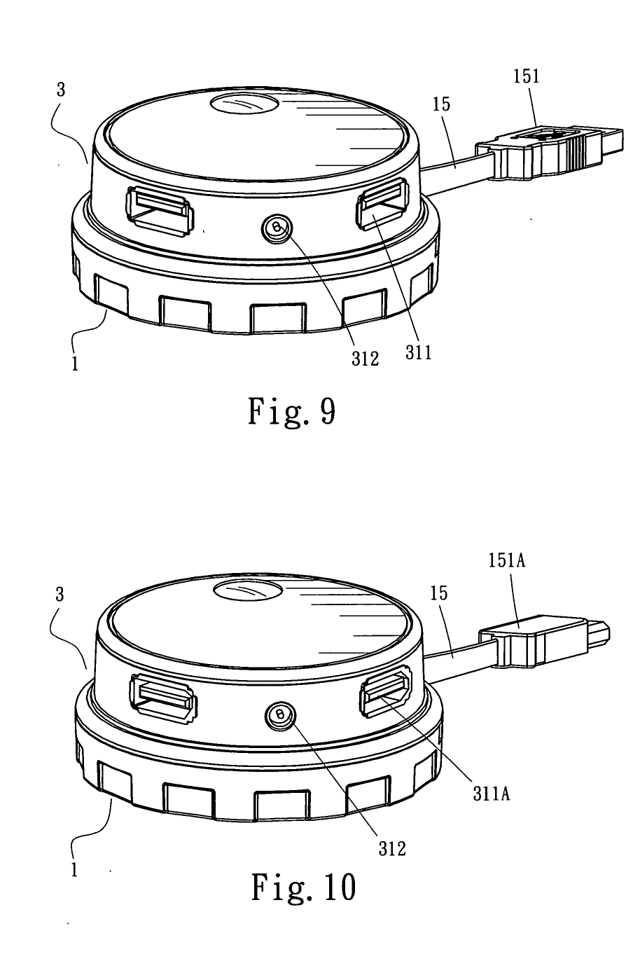

In actual applications of pairing the USB HUB 3 with the cable winding reel 1, the terminal 316 of the extension cord 315 of the printed circuit board 3 is connected to the terminal 142 of the cover 14 of the cable winding reel 1. Screws 317 are inserted into the screw openings 314 and threaded to the screw holes 143 of the cover 14. The hood 32 and top lid 33 are then mounted to complete the pairing of the USB HUB 3 and cable winding reel 1, as shown in FIGS. 1, 8 and 9.

In actual pairing of the cable winding reel 1 and assembly is not limited to the structure as disclosed in this invention, but may adopt any structure of winding reels that incorporating the connection approach of this invention.

As shown in FIG. 10, the USB plug 151 provided at the end of the signal/power cable 15 of the cable winding reel 1 and the USB sockets 311 in the USB HUB 3 may be replaced with an IEEE 1394 plug 151A and IEEE 1394 sockets 311A to serve as the connecting device for an IEEE 1394 interface, or PS2 or RJ45 plug and sockets, thereby serving as a HUB device featured with reeling function for a PS2 or an RJ45 interface.

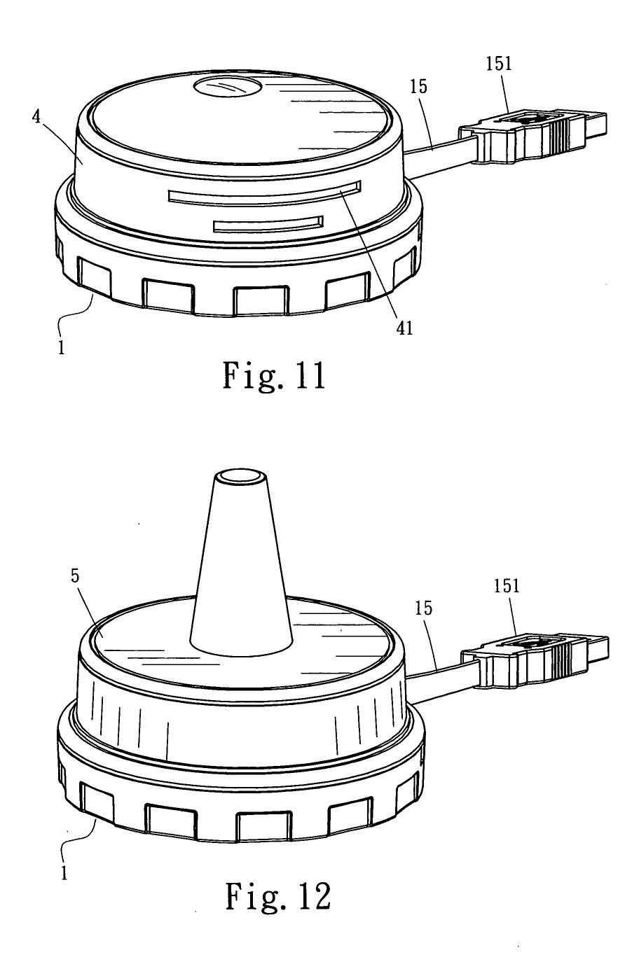

As shown in FIG. 11, the pairing of the cable winding reel 1 and USB HUB 3 may be modified such that the assembly is made into a card reader 4 such that a flash memory chip may be inserted through a groove 41 of the card reader 4, thereby serving as a card reader featured with reeling function.

As shown in FIG. 12, the pairing of the cable winding reel 1 and USB HUB 3 may be modified such that the assembly is made into a net wireless transmitter 5, thereby serving as a net wireless transmitter featured with reeling function.

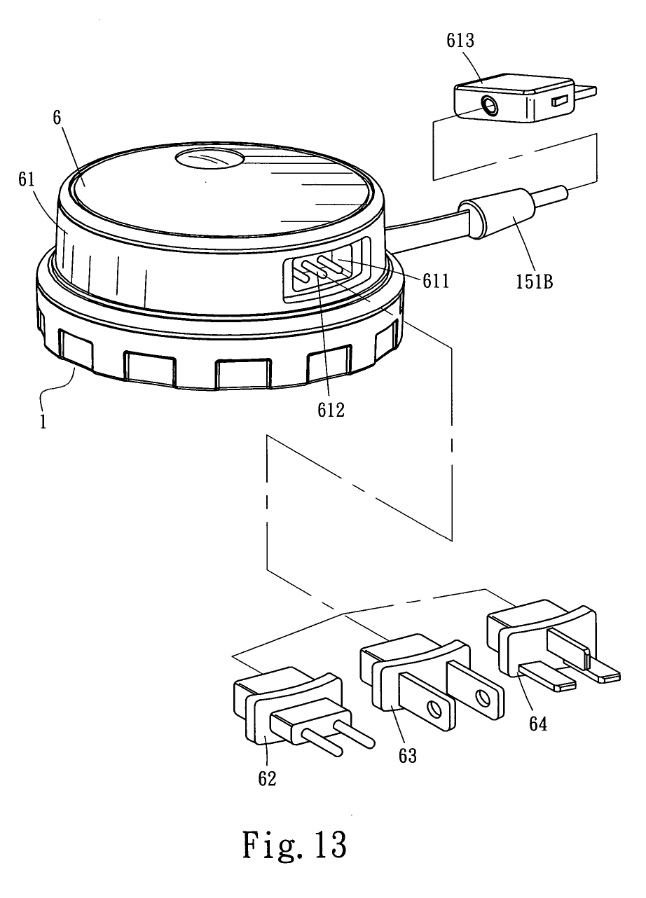

As shown in FIG. 13 the USB plug 151 provided at the end of the signal/power cable 15 of the cable winding reel 1 may be replaced with a DC terminal 151B and the USB HUB 3 with a power transformer 6, while the casing 61 is provided thereto with a connecting port 611 having conductive leads 612 to which a variety of DC plugs 62, 63, 64 may be connected. Such that after inserting the plugs 62, 63, 64 into the connecting port 611 and the conductive leads 612 being electrically connected to an AC power source through the plugs 62, 63, 64, AC current may be transformed into DC current to serve as the power source of products employing DC current. The DC terminal 151B may be connected to other terminal 613 so as to serve as a mobile phone charger. Thus, the pairing of the cable winding reel 1 of this invention with a power transformer 6 may serve as a power transformer device for products employing DC current.

In summary, this invention may be so combined that the cable winding reel 1 is randomly paired with and adapted to any kind of assembly 2 such as a HUB 3, a card reader 4, a net wireless transmitter 5 or a power transformer 6, where the assembly is not limited to the HUB 3, card reader 4, net wireless transmitter 5 or power transformer 6 as described in the embodiments. Any pairing by such a manner with the cable winding reel 1 is contemplated by the scope of this invention.

1. A cable winding reel and adaptor connecting device, including a cable winding reel to be selectively paired with and adapted to an assembly, characterized in that, the connecting device may randomly be paired with and adapt to a HUB, card reader, net wireless transmitter or power transformer,

2. A cable winding reel and adaptor connecting device, wherein the assembly in the device, in actual applications, may be a HUB for USB, IEEE 1394 or PS2 interfaces, a card reader, a net wireless transmitter, a power transformer 6 or any other assembly of power or electronic devices.

3. The cable winding reel and adaptor connecting device of claim 1, wherein the cable winding reel and assembly are each provided with connectors to allow connection of power/signal cables upon pairing.

4. The cable winding reel and adaptor connecting device of claim 1, wherein the cable winding reel includes:
a casing having an open end and an inner periphery serving as a receiving compartment that is provided at a center thereof with a vertical post formed with a groove at an end, the casing being provided at the inner circumferential periphery with an arcuate block, at an outer periphery with a leading bore for leading out the signal/power cable, and at a top edge thereof with a clip;
a retaining disc and a control disc being each provided with a central bore corresponding to the vertical post, and placed in the receiving compartment of the casing in order; the retaining disc being is provided at an outer edge thereof with a set of resilient member having a protrusion at an outer edge thereof and a flange facing upwards; the control disc being provided with two symmetrical arcuate slots at locations corresponding to a circumferential line of the flange, such that that flange may be inserted into either arcuate slot;
a cover being provided at a center thereof with a tubular opening extending downwards, a terminal and screw holes, the tubular opening including an outer periphery about which a signal/power cable may wind; the signal/power cable having an end that is led out from the leading bore, and another end being connected to a USB plug, where the USB plug, if necessary, may be replaced with an IEEE 1394 plug, a PS2 plug, or an RJ45 plug, the other end of the signal/power cable passing through the cover and connected to the terminal; the tubular opening of the cover having a hollow part into which a resilient spring is provided; the resilient spring having an end being affixed to the groove of the vertical post, and another end being affixed to a notch of the cover; the tubular opening being covered by a lid over a top opening thereof; and
a frame engaging over a top edge of the cable winding reel.

5. The cable winding reel and adaptor connecting device of claim 4, wherein the cable winding reel is controlled in such a manner that, the casing is provided at a bottom thereof with a retaining indent and two retaining blocks; the retaining blocks are provided thereto with posts; the cover is provided with an inclined guide facing downwards at a location corresponding to the posts, such that the posts are able to slide along the inclined guide, whereby the retaining blocks may be retained by or disengage from the retaining indent to achieve intended reeling.

6. The cable winding reel and adaptor connecting device of claim 1, wherein the casing is provided at a central outer edge thereof, if necessary, with an assembly device, the assembly device having an axis that is provided with a screw hole or a retainer that may be adapted to the screw rod of a rubber or magnetic sucking disc thereby attaching the cable winding reel and adaptor connecting device of this invention to a glass or metal sheet.

7. The cable winding reel and adaptor connecting device of claim 1, wherein the assembly is a USB HUB having a printed circuit board, a hood and a top lid, the printed circuit board being provided thereto with USB sockets, a power input terminal, an LED, and screw openings at opposing ends thereof, circuitry on the printed circuit board being connected to an extension cord at a backside thereof, the extension cord being provided at an end thereof with a terminal mating with the terminal provided to the cover of the cable winding reel.

8. The cable winding reel and adaptor connecting device of claim 6, wherein the hood is provided at locations corresponding to the USB sockets and power input terminal with USB socket openings, a power input opening and a positioning hole at a top side thereof, the hood being covered with the top lid for covering a top opening thereof, the top lid being provided at a location corresponding to the LED with a light-pervious plate, the top lid being covered over and secured to the hood by inserting a post extending downwards into the positioning hole.

9. The cable winding reel and adaptor connecting device of claim 6, wherein in pairing the USB HUB with the cable winding reel, the terminal of the extension cord of the printed circuit board is connected to the terminal of the cover of the cable winding reel, screws are inserted into the screw openings and threaded to the screw holes of the cover, the hood and top lid are then mounted to complete the pairing of the USB HUB and cable winding reel.

10. The cable winding reel and adaptor connecting device of claim 1, wherein the pairing of the cable winding reel and assembly is not limited to the structure as disclosed in this invention, but may adopt any structure of winding reels that incorporates the connection approach of this invention.

11. The cable winding reel and adaptor connecting device of claim 1, wherein the USB plug provided at the end of the signal/power cable of the cable winding reel and the USB sockets in the USB HUB may be replaced with an IEEE 1394 plug and IEEE 1394 sockets 311 A to serve as the connecting device for an IEEE 1394 interface, or PS2 or RJ45 plug and sockets, thereby serving as a HUB device featured with reeling function for a PS2 or an RJ45 interface.

12. The cable winding reel and adaptor connecting device of claim 6, wherein the assembly is made into a card reader such that a flash memory chip may be inserted through a groove of the card reader, thereby serving as a card reader featured with reeling function.

13. The cable winding reel and adaptor connecting device of claim 6, wherein the assembly is made into a net wireless transmitter, thereby serving as a net wireless transmitter featured with reeling function.

14. The cable winding reel and adaptor connecting device of claim 6, wherein the assembly is made into a power transformer, thereby serving as a power transformer featured with reeling function.

15. The cable winding reel and adaptor connecting device of claim 13, wherein in the power the transformer, the USB plug provided at the end of the signal/power cable of the cable winding reel is replaced with a DC terminal and the USB HUB with a power transformer, while the casing is provided thereto with a connecting port having conductive leads to which a variety of DC plugs are connected, such that after inserting the plugs into the connecting port and electrically connecting the plugs to an AC power source, AC current may be transformed into DC current to serve as the power source of products employing DC current, such as a mobile phone charger.
